(19) United States
(12) Patent Application Publication
(10) Pub. No.: US 2012/0091845 A1
(43) Pub. Date: Apr. 19, 2012

(54) BRUSHLESS MOTOR

(75) Inventors: Yoshiaki TAKEMOTO, Toyohashi-shi (JP); Shinji SANTO, Kosai-shi (JP); Kenta GOTO, Hamamatsu-shi (JP); Shigemasa KATO, Toyohashi-shi (JP)

(73) Assignee: ASMO CO, LTD., Shizuoka-ken (JP)

(21) Appl. No.: 13/274,082

(22) Filed: Oct. 14, 2011

(30) Foreign Application Priority Data
Oct. 19, 2010 (JP) 2010-234483
Oct. 5, 2011 (JP) 2011-221224

(51) Int. Cl. H02K 21/12

(52) U.S. Cl. 310/156.01

(57) ABSTRACT

A brushless motor includes a rotor and a stator. The rotor is provided with a rotor core including a plurality of magnet poles and a plurality of core poles. A void is formed at a boundary between each core pole and an adjacent magnet pole in the circumferential direction. Each magnet pole includes a peripheral core portion located closer to the stator than the magnet in the radial direction of the rotor. The void formed in at least one of two circumferential sides of each magnet pole includes an extended void region that extends into the peripheral core portion toward a middle point of the magnet pole in the circumferential direction.

### BACKGROUND OF THE INVENTION

The present invention relates to a brushless motor including a rotor with a consequent-pole structure.

A brushless motor includes a rotor and a stator (refer to, for example, Japanese Laid-Open Patent Publication No. 2004-201406). The rotor includes a rotor core. The rotor core includes a plurality of magnet poles (referred hereafter as the magnet poles) and a plurality of core magnet poles (hereafter referred to as the core poles). The magnet poles are arranged in the circumferential direction of the rotor core. Each of the core poles is arranged between two magnet poles that are adjacent to each other in the circumferential direction. A magnet is embedded in each magnet pole. A void is formed at a boundary between the core pole and the magnet pole that are adjacent to each other in the circumferential direction. The stator includes a plurality of teeth arranged at equal angular intervals in the circumferential direction. The teeth face the rotor in the radial direction. Coils are set on the teeth of the stator. In such a brushless motor, the number of magnets used in the rotor is decreased by one half without significantly lowering performance. Thus, the brushless motor is advantageous in that it requires fewer resources and reduces costs.

In the brushless motor described in the publication, when there is more than one tooth facing a single magnet, that is, when the adjacent tooth also faces the same magnet pole in the radial direction, the adjacent tooth may demagnetize the magnet pole. This may cause a torque decrease that lowers the rotation performance of the rotor.

### SUMMARY OF THE INVENTION

It is an object of the present invention to provide a brushless motor including a rotor with a consequent-pole structure that reduces demagnetization, increases the torque, and improves the rotation performance.

To achieve the above object, one aspect of the present invention provides a brushless motor provided with a rotor including a rotor core. The rotor core includes a plurality of magnet poles, which are arranged in a circumferential direction of the rotor core, and a plurality of core poles, each arranged between two adjacent ones of the magnet poles in the circumferential direction. A magnet is embedded in each of the magnet poles. A void is formed at a boundary between each of the core poles and an adjacent one of the magnet poles in the circumferential direction. A stator includes a plurality of teeth, which are arranged at equal angular intervals in the circumferential direction facing the rotor in a radial direction of the rotor, and a plurality of coils, each wound around the teeth. Each magnet pole includes a peripheral core portion located closer to the stator than the corresponding magnet in the radial direction of the rotor. At least one of the two voids formed at opposite circumferential sides of each magnet pole includes an extended void region that extends into the corresponding peripheral core portion and toward a middle point of the magnet pole in the circumferential direction.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing the structure of a brushless motor according to one embodiment of the present invention;

FIG. 2 is a plan view showing part of the rotor shown in FIG. 1;

FIG. 3 is a perspective view showing a magnet pole shown in FIG. 1;

FIG. 4 is a graph showing characteristic curves indicating the relationship between the tilt angle of magnets and the change rate of magnetic flux;

FIG. 5 is a plan view showing part of a rotor in a further embodiment;

FIG. 6 is a perspective view showing a magnet pole of the rotor in another embodiment;

FIG. 7 is a plan view showing part of a rotor in a further embodiment of the present invention;

FIG. 8 is a graph showing the characteristic curves indicating the relationship between the ratio W2/W1 (the ratio of the magnet width W2 to the circumferential width W1 of the first opposing surface) and the change rate of magnetic flux;

FIG. 9 is a schematic diagram showing part of a brushless motor structure in which the edge depth E is set at 0;

FIG. 10 is a schematic diagram showing part of a brushless motor structure in which the edge depth E is set at 0;

FIG. 11 is a plan view showing part of a rotor in a further embodiment of the present invention; and

FIG. 12 is a plan view showing part of a rotor in a further embodiment of the present invention.

### DETAILED DESCRIPTION OF THE INVENTION

One embodiment of the present invention will now be described with reference to the drawings.

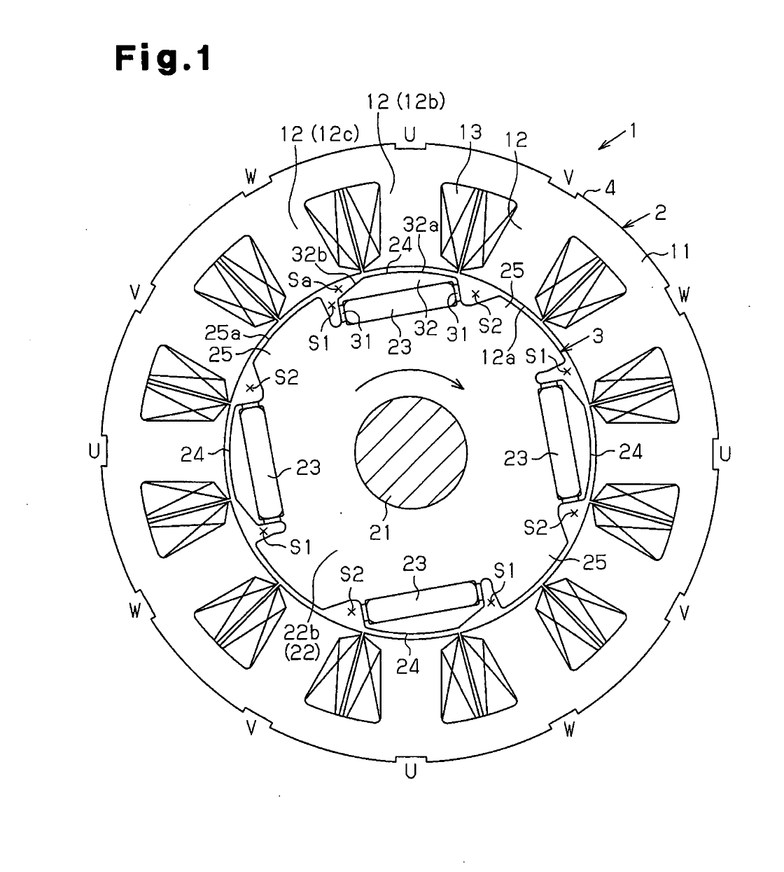

As shown in FIG. 1, an inner rotor type brushless motor 1 of the present embodiment includes an annular stator 2 and a rotor 3 arranged inward in the radial direction from the stator 2.

The stator 2 includes a stator core 4. The stator core 4 includes an annular part 11 and a plurality of (twelve in the present embodiment) teeth 12. The teeth 12 are arranged in the circumferential direction and extend inward in the radial direction from the annular part 11. The stator core 4 is formed by a stacking a plurality of core sheets in the axial direction. Each core sheet is formed by a metallic sheet having high permeability. A coil 13 is wound around each tooth 12 of the stator core 4 with an insulator (not shown) arranged in between. The coils 13 generate magnetic field, which rotates the rotor 3. Each coil 13 is wound around a predetermined one of the teeth 12 and forms one of three-phases, namely, a U-phase, a V-phase, and a W-phase. Each coil 13 is wound in the same direction (counterclockwise when viewed the teeth 12 from the inner circumferential side) into a concentrated winding. Each tooth 12 has a curved distal surface 12a, and the distal surfaces 12a of the teeth 12 lie along the same circle.

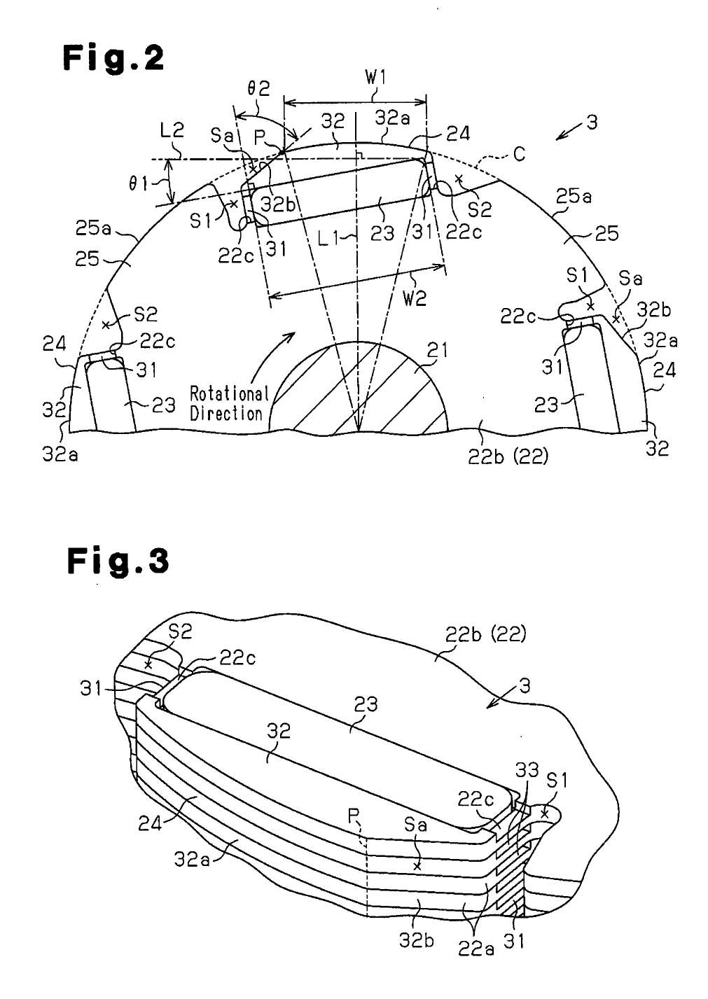

As shown in FIGS. 1 and 2, the rotor 3 includes a rotor core 22 having an annular shape. A rotary shaft 21 is fitted into the rotor core 22. In the same manner as the stator core 4, the rotor core 22 is formed by stacking core sheets 22a (refer to FIG. 3) in the axial direction. Each core sheet 22a is a metallic sheet having high permeability. Four magnets 23 functioning as north poles are embedded in the rotor core 22 near the outer circumferential surface of the rotor core 22. The magnets 23 are arranged at equal angular intervals (intervals of 90 degrees) in the circumferential direction. Each magnet 23 is formed by a generally rectangular plate. The rotor core 22 also includes two bridges 31 and a peripheral core portion 32 for each magnet 23. The bridges 31 extend in the circumferential direction along opposite side surfaces of the magnet 23. The peripheral core portion 32 is arranged outward in the radial direction from the magnet 23 (toward the stator 2 from the rotor core 22) and is supported by the two bridges 31. The peripheral core portion 32 and the magnet 23 form a magnet pole 24. Thus, four magnet poles 24 are arranged at equal angular intervals of 90 degrees on the outer circumference of the rotor core 22.

Core poles 25, which project from the rotor core 22, are arranged between adjacent magnet poles 24 with voids S1 and S2 formed at boundaries between the magnet poles 24 and the core poles 25. The voids S1 and S2 are arranged at two opposite sides of each magnet pole 24 in the circumferential direction. The void S1 is located at the rear side of the magnet pole 24 relative to the rotation direction of the rotor 3 (clockwise in FIGS. 1 and 2). The void S2 is located at the front side of the magnet pole 24 relative to the rotation direction of the rotor 3. The magnets 23 and the core poles 25 are arranged alternately at equal angular intervals (intervals of 45 degrees) in the circumferential direction. The rotor 3 includes eight magnet poles in total and has a consequent-pole structure in which the magnets 23 function as north poles and the core poles 25 function as south poles. Each core pole 25 has a curved surface 25a (surface facing the stator 2), and the curved surfaces 25a of the core poles 25 lie along the same circle C as viewed from the axial direction. As shown in FIG. 2, the circle C is a hypothetical circle extending along the outer circumference of the rotor 3.

Each pair of bridges 31 in the rotor core 22 is in contact with the two circumferential side surfaces of the corresponding magnet 23 and connects the corresponding peripheral core portion 32 to a central portion (main core portion 22b) of the rotor core 22. The peripheral core portions 32 and the main core portion 22b are in contact with the surfaces of the magnets 23 (the two opposite surfaces of the magnets 23 in the radial direction). In this manner, the magnets 23 are in contact with the rotor core 22 on its four sides as viewed in the axial direction. Thus, the magnets 23 are rigidly held in the rotor core 22.

As shown in FIG. 3, each bridge 31 includes a plurality of holes 33 arranged in the axial direction and extending in the circumferential direction. In detail, each core sheet 22a of the rotor core 22 includes a recess 22c, which hollows in the axial direction. The holes 33 in the bridge 31 are formed by the recesses 22c of the core sheets 22a.

As shown in FIGS. 1 and 2, each peripheral core portion 32 has a surface facing the distal surface 12a of the teeth 12. The surface facing the distal surface 12a of the tooth 12 is formed by a first opposing surface 32a and a second opposing surface 32b, which are arranged in the circumferential direction. In detail, the first opposing surface 32a extends from a first circumferential end of the peripheral core portion 32 (front end in the rotation direction) to a predetermined circumferential intermediate position P. The second opposing surface 32b extends from the circumferential intermediate position P of the peripheral core portion 32 to a second circumferential end (rear end in the rotation direction). In other words, the surface of the peripheral core portion 32 is formed by the first opposing surface 32a, which is located at the front side relative to the rotation direction of the rotor 3, and the second opposing surface 32b, which is located at the rear side relative to the rotation direction of the rotor 3.

The first opposing surfaces 32a are curved and lie along the same circle C as viewed in the axial direction. Thus, the first opposing surfaces 32a of the peripheral core portions 32 lie along the same circle C as the surfaces 25a of the core poles 25. Further, the first opposing surfaces 32a are spaced apart from the teeth 12 in the radial direction by a distance that is constant in the circumferential direction. Each first opposing surface 32a has a circumferential width W1 that is equal to the circumferential width of the distal surface 12a of each tooth 12 (i.e., the surface facing the rotor 3 in the radial direction).

The second opposing surfaces 32b are flat. The circumferential width of each second opposing surface 32b is less than the circumferential width W1 of each first opposing surface 32a. As viewed in the axial direction, the second opposing surfaces 32b are located inward in the radial direction from the circle C along which the first opposing surfaces 32a lie. In other words, the distance between each second opposing surface 32b and the teeth 12 is greater than the distance between each first opposing surface 32a and the teeth 12. The second opposing surface 32b is formed so that the distance from the teeth 12 in the radial direction gradually increases in the circumferential direction from the intermediate position P of the corresponding peripheral core portion 32 to the second circumferential end of the peripheral core portion 32.

As described above, the first opposing surfaces 32a of the peripheral core portions 32 are located on the circle C, whereas the second opposing surfaces 32b of the peripheral core portions 32 are located inward in the radial direction from the circle C. In this structure, each void S1, which is located at the rear side of the corresponding magnet pole 24 relative to the rotation direction, extends to a region located outward in the radial direction from the magnet pole 24 (toward the stator 2). The extended region of the void S1 (hereafter referred to as the extended void region Sa) extends along the second opposing surface 32b to the circumferential intermediate position P of the corresponding peripheral core portion 32. In detail, the extended void region Sa extends from an outer radial end of the void S1 to the middle part of the peripheral core portion 32 in the circumferential direction (toward the middle point of the magnet pole). As a result, the extended void region Sa extends to a position located outward in the radial direction (toward the stator 2) from the magnet 23 arranged in the magnet pole 24. When viewed from the axial direction, the void S2, which is located at the front side in the rotational direction, has an area T2, and the void S2, which is located at the rear side in the rotational direction, has an area T1 (T1 is the area including the extended void region Sa) that is set to be equal to the area T2. That is, T2=T1 is set.

As shown in FIG. 2, each magnet 23, which has two parallel long sides and two parallel short sides, is arranged so that its long sides, as viewed in the axial direction, are inclined at a magnet inclination angle θ1 relative to a straight line L2 that is orthogonal to a straight line L1 extending in the radial direction of the stator core 4 through the middle point of the first opposing surface 32a of the peripheral core portion 32 in the circumferential direction. The magnet 23 is inclined so that its rear end relative to the rotation direction is closer to the center of the rotor 3, as viewed in the axial direction. The magnet width W2, which is the distance between the two ends of the magnet 23 in the circumferential direction, is greater than the width W1 of the first opposing surface 32a in the circumferential direction. Further, each second opposing surface 32b is inclined relative to a direction orthogonal to the long sides, or longitudinal direction, of the magnet 23 (the direction in which the short sides of the magnet 23 extends) at a void inclination angle θ2.

In the brushless motor 1, the coils 13 are supplied with a driving power to generate a rotational magnetic field that rotates the rotor 3 in the clockwise direction. In this state, the magnet poles 24 generate torque that rotates the rotor 3 mainly at the first opposing surfaces 32a of the peripheral core portions 32. When one first opposing surface 32a faces one tooth 12 (e.g., tooth 12b in FIG. 1), the adjacent tooth 12 (the tooth 12c) faces the corresponding second opposing surface 32b. The gap between the second opposing surface 32b and the tooth 12c is large due to the presence of the extended void region Sa. This reduces demagnetization in the magnet pole 24 caused by the tooth 12c. As a result, the torque is increased, and the rotation performance is improved. Further, the magnet 23 is inclined so that the surface of the peripheral core portion 32 becomes farther as the rear end of the magnet 23 in the rotation direction becomes closer. This reduces the influence of the tooth 12c on the magnet pole 24.

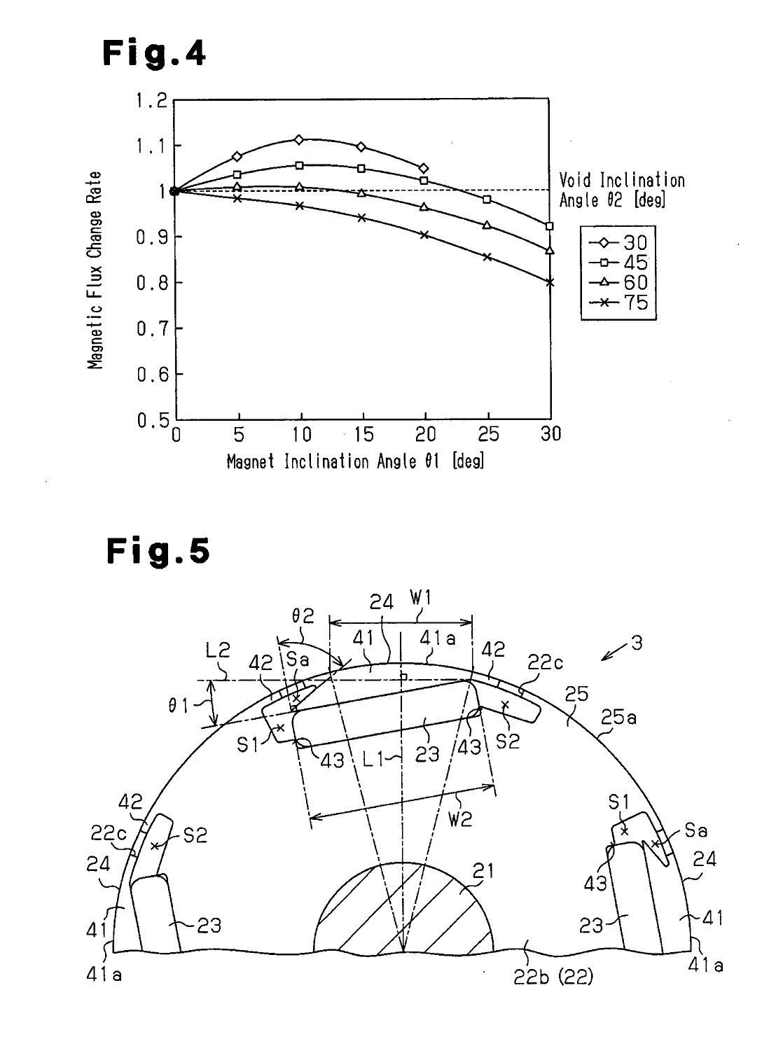

FIG. 4 shows the change rate of the magnetic flux produced by the magnet pole 24 when the magnet inclination angle θ1 is varied in the range of 0 to 30 degrees. FIG. 4 shows four cases in which the void inclination angle θ2 is set at 30, 45, 60, and 75 degrees, respectively. In FIG. 4, the magnet inclination angle θ1 that is set at 0 degree is used as a reference (in which the magnetic flux change rate is 1). When the void inclination angle θ2 is 30 degrees and 45 degrees and the magnet inclination angle θ1 is in the range of 0 to approximately 22.5 degrees, the magnetic flux change rate is greater than 1. This suggests that the magnetic flux density increases and is in a satisfactory range when the void inclination angle θ2 is set to 45 degrees or less and the magnet inclination angle θ1 is set in the range of 0°≦θ2≦22.5°. In the present embodiment, the void inclination angle θ2 and the magnet inclination angle θ1 are set in the above range to increase the magnetic flux density.

The above embodiment has the advantages described below.

(1) In the present embodiment, the void S1 between each magnet pole 24 and the adjacent core pole 25 includes the extended void region Sa, which extends into the peripheral core portion 32 toward the middle point of the magnet pole 24 in the circumferential direction. As a result, the extended void region Sa is arranged between the teeth 12 and part of each magnet pole 24 in the circumferential direction. When not only one tooth 12 faces the magnet pole 24 but the adjacent tooth 12 also faces the same magnet pole 24 in the radial direction, the extended void region Sa reduces the influence of the adjacent tooth 12 on the magnet pole 24. This reduces demagnetization in the magnet pole 24 caused by the adjacent tooth 12. As a result, the torque is increased, and the rotation performance is improved.

(2) In the present embodiment, each peripheral core portion 32 includes the first opposing surface 32a, which faces the teeth 12 and is spaced apart from the opposing tooth 12 by a first distance, and the second opposing surface 32b, which faces the teeth 12 and is spaced apart through the extended void region Sa from the corresponding teeth 12 by a second distance that is larger than the first distance. Thus, when one first opposing surface 32a faces not only the single tooth 12 but also the adjacent tooth 12, this ensures that demagnetization in the magnet pole 24 caused by the adjacent tooth 12 is reduced.

(3) In the present embodiment, the width W1 of the first opposing surface 32a in the circumferential direction is equal to the width of the distal surface 12a of each tooth 12 in the circumferential direction. This efficiently generates torque with the first opposing surfaces 32a. As a result, even though the second opposing surfaces 32a reduce demagnetization, the decrease in torque is minimized.

(4) In the present embodiment, each magnet 23 is formed by a rectangular plate. The magnet 23 is arranged so that its long sides, as viewed in the axial direction of the rotor 3, are inclined at the magnet inclination angle θ1 relative to the straight line L2 that is orthogonal to the straight line L1 extending in the radial direction of the stator core 4 through the middle point of the first opposing surface 32a in the circumferential direction. The second opposing surface 32b is flat and inclined at the void inclination angle θ2 relative to the direction in which the short sides of the corresponding magnet 23 extend. The magnet inclination angle θ1 is set in the range of 0°≦θ1≦22.5°. The void inclination angle θ2 is set in the range of θ2≦45°. This increases the magnetic flux density (refer to FIG. 4) ensures further improvement in the rotation performance of the rotor 3.

(5) In the present embodiment, each bridge 31 includes the holes 33 arranged in the axial direction. The holes 33 reduce passage of magnetic flux through the bridge 31 and prevent leakage of the magnetic field from the bridge 31.

(6) In the present embodiment, the rotor core 22 the core sheets 22a that are stacked in the axial direction. The recesses 22c in the core sheets 22a form the holes 33 of each bridge 31. The holes 33 are easily formed in each bridge 31 of the rotor core 22 by forming the recess 22c in each core sheet 22a and then stacking the core sheets 22a.

(7) In the present embodiment, the rotor 3 is rotatable in only one direction (clockwise direction as viewed in FIG. 1). Each magnet 23 is inclined so that portions closer to the front relative to the rotation direction are closer to the surface of the rotor 3 (i.e., the surface of the corresponding peripheral core portion 32). This increases the rotation torque.

It should be apparent to those skilled in the art that the present invention may be embodied in many other specific forms without departing from the spirit or scope of the invention. Particularly, it should be understood that the present invention may be embodied in the following forms.

In the above embodiment, the rotor 3 rotates in the clockwise direction. However, the rotation direction of the rotor 3 may be changed to the counterclockwise direction without changing the structure of the rotor 3.

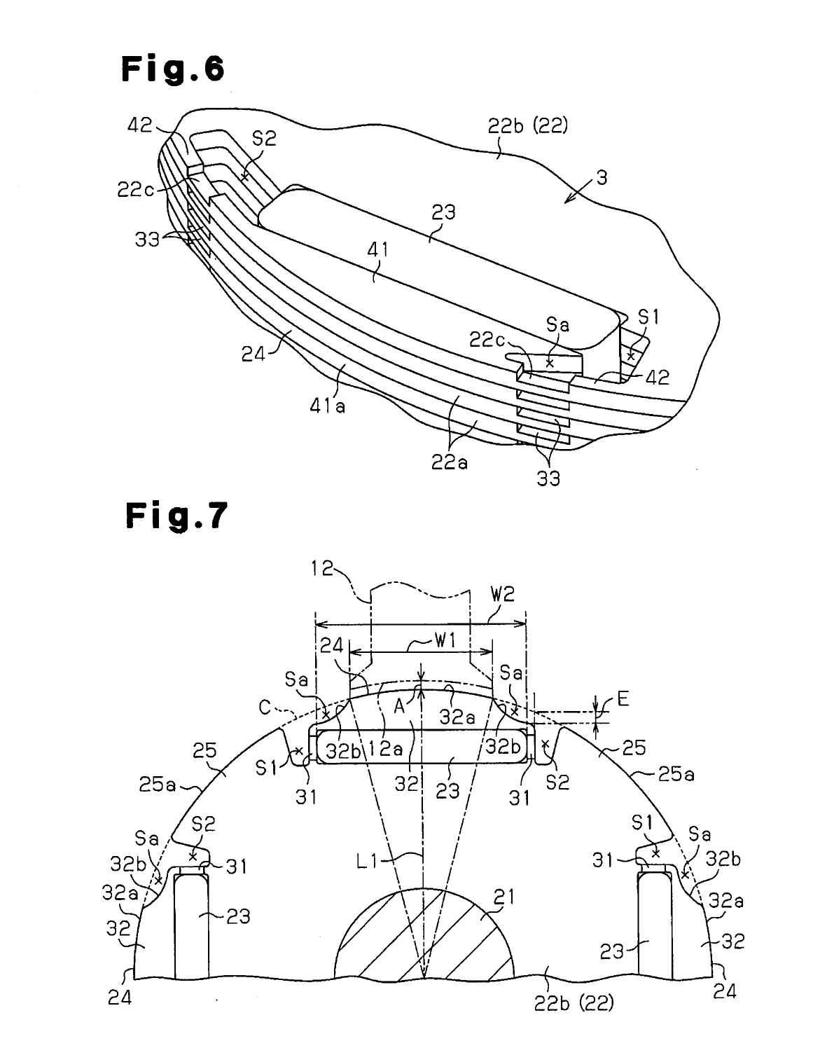

In the above embodiment, the bridges 31 are arranged on the two opposite ends of each magnet 23 in the circumferential direction. The voids S1 and S2 formed between the magnet poles 24 and the core poles 25 function as grooves that open outward in the radial direction. However, the present invention is not limited in such a manner. The bridges 31 may be modified to, for example, bridges 42 shown in FIGS. 5 and 6. The bridges 42 extend in the circumferential direction of the rotor core 22 to connect the peripheral core portions 41 and the core poles 25. The bridges 42 extend in the circumferential direction from two opposite ends of each peripheral core portion 41 and are connected to the surfaces 25a of the adjacent core poles 25. In the structure shown in FIGS. 5 and 6, the surface of the rotor 3 is formed by the outer circumferential surfaces of the bridges 42 in addition to the surfaces 41a and 25a of the peripheral core portion 41 and the core pole 25. The width W1 of the surface 41a of each peripheral core portion 41 (i.e., the surface facing the teeth 12) in the circumferential direction is equal to the width of the distal surface 12a of each tooth 12 in the circumferential direction. The rotor core 22 includes engagement projections 43, which prevent displacement of the magnets 23. The bridges 42 are not in contact with the two opposite ends of the corresponding magnets 23 in the circumferential direction. In this case, the magnets 23 are easily embedded in the rotor core 22. In the structure shown in FIGS. 5 and 6, the bridges 42 cover the outer side (portion closer to the stator 2) of the voids S1 and S2 between the magnet poles 24 and the core poles 25. The extended void region Sa of each void S1 extends into the corresponding peripheral core portion 41. This structure also has the same advantages as the above embodiment.

In the above embodiment, each peripheral core portion 32 includes a single first opposing surface 32a and a single second opposing surface 32b. However, the present invention is not limited to such a structure. As shown in FIG. 7, for example, each peripheral core portion 32 may include a first opposing surface 32a located in the middle of the surface of the peripheral core portion 32 in the circumferential direction and two second opposing surfaces 32b located at the two opposite sides of the first opposing surface 32a in the circumferential direction. In this structure, the voids S1 and S2 at the two circumferential ends of each magnet pole 24 each include an extended void region Sa. This structure may be used when the rotor 3 is rotatable in both forward and rearward directions. When one first opposing surface 32a faces one tooth 12 and an adjacent tooth 12, this structure reduces demagnetization in the magnet pole 24 caused by the adjacent tooth 12 in a preferable manner regardless of whether the rotor 3 rotates in the forward direction or the rearward direction.

In the structure shown in FIG. 7, the second opposing surfaces 32b are curved toward the center of the rotor 3. In other words, the second opposing surfaces 32b are curved away from the stator 2 as viewed in the axial direction. In this structure, the distance between the peripheral core portion 32 and the teeth 12 suddenly changes at the two circumferential ends of the peripheral core portion 32. This reduces demagnetization at the second opposing surfaces 32b in a preferable manner.

In the structure shown in FIG. 7, the magnets 23 are arranged so that its longitudinal direction, as viewed in the axial direction, is orthogonal to a straight line L1 that extends in the radial direction of the rotor core 22 through the circumferential middle point of the magnet pole 24. Each magnet pole 24 is symmetric relative to the straight line L1.

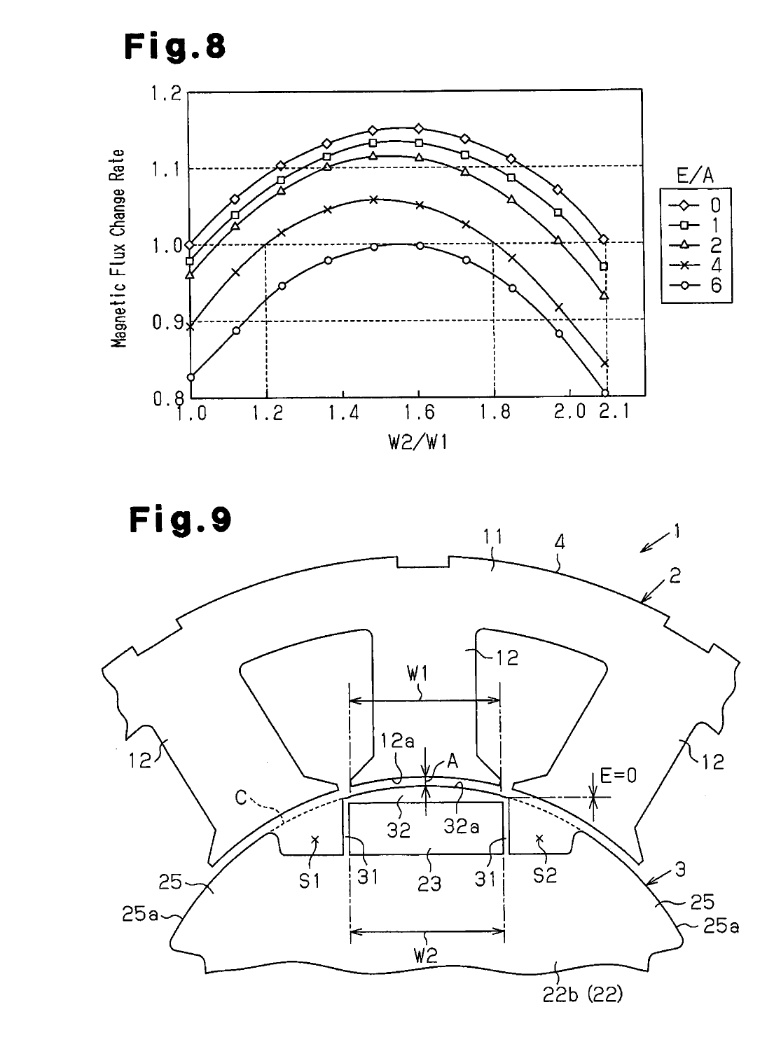

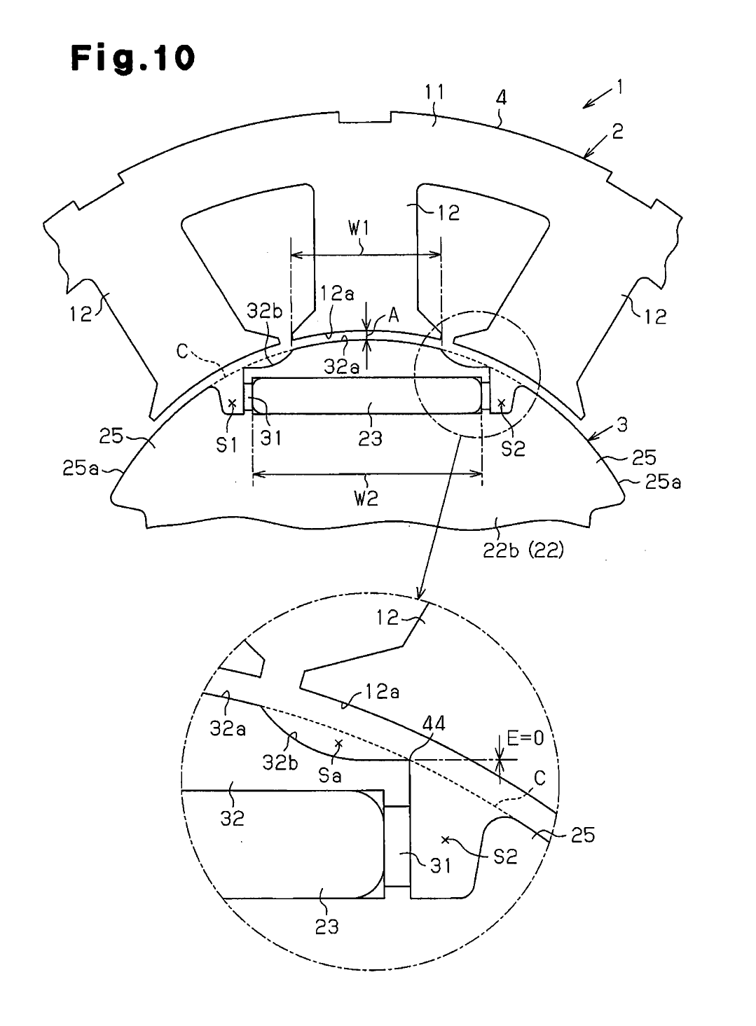

FIG. 8 shows the change rate of the magnetic flux at the magnet poles 24 in the structure shown in FIG. 7 when the ratio W2/W1 is varied. The ratio W2/W1 is the ratio of the width W2 of the magnet 23 and the width W1 of the first opposing surface 32a in the circumferential direction. FIG. 8 shows five cases in which the ratio E/A is set at 0, 1, 2, 4, and 6, respectively. The ratio E/A is the ratio of the distance E from the two ends of the peripheral core portion 32 in the direction parallel to the short sides of the magnet 23 (the vertical direction in FIG. 7) to the circle C (edge depth E in FIG. 7) and the distance A (air void A) in the radial direction from the first opposing surface 32a (the circle C) to the distal surface 12a of the tooth 12. FIG. 9 is a referential diagram showing a structure in which the edge depth E is 0 is substantially equal to the magnet width W2 and the circumferential width W1 of the first opposing surface 32a (i.e., structure of ratio W2/W1≈1). FIG. 10 shows a structure in which the edge depth E is 0 and the ratio W2/W1=1.49. In the structure shown in FIG. 10, the edge width E=0 is satisfied and an edge 44 at each of the two ends of each peripheral core portion 32 lies along the circle C. However, the first opposing surface 32a, the second opposing surfaces 32b, and the extended void region Sa are formed in the surface of each peripheral core portion 32. The structure shown in FIG. 10 thus has the same advantages as the structure shown in FIG. 7, specifically, the extended void region Sa reduces demagnetization. FIG. 8 is a graph showing the characteristics when the width W1 of the first opposing surface 32a in the circumferential direction is set equal to the distal surface 12a of the tooth 12 and the volume of the magnet 23 is constant as shown in FIGS. 9 and 10 and the magnet width W2 is varied.

In FIG. 8, the edge depth ratio E/A that is set at 0 is used as a reference (in which the magnetic flux change ratio is 1). When the edge depth ratio E/A is set at 0 and the ratio W2/W1 in the range of 1.0<W2/W1<2.1, the magnetic flux density increased and is thus in a satisfactory range. The structure in which the edge depth ratio E/A is set at 0 and the ratio W2/W1 is set in the range of 1.0<W2/W1<2.1 reduces demagnetization, and increases the torque, and improves the rotation performance. The edge depth ratio E/A set at 4 or less and the ratio W2/W1 set in the range of 1.2<W2/W1<1.8 also increase the magnetic flux density in an optimum manner. The structure in which the edge depth ratio E/A is set at 4 or less and the ratio W2/W1 is set in the range of 1.2<W2/W1<1.8 reduces demagnetization, increases the torque, and improves the rotation performance. When the edge depth ratio E/A is 6, the magnetic flux change ratio is 1 or less regardless of the ratio W2/W1.

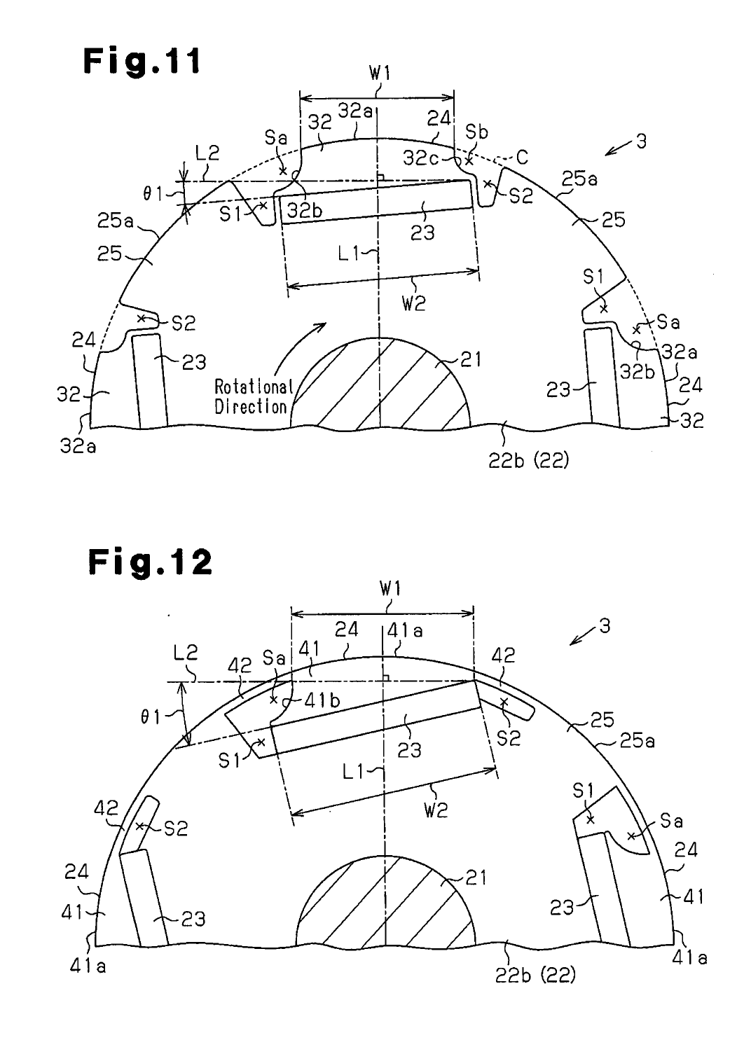

In the structure shown in FIG. 7, each of the magnet pole 24 and the core pole 25 are arranged to be symmetric relative to a circumferential middle line but not particularly limited to such a structure. For example, the magnet pole 24 and core pole 25 may be in an asymmetric arrangement such as that shown in FIG. 11. In this case, the circumferentially middle part in the surface of the peripheral core portion 32 defines the first opposing surface 32a. Further, the opposite sides of the first opposing surface 32a defines the second opposing surfaces 32b and 32c, which are inwardly curved. In this structure, the void S1 includes an extended void region Sa, and the void S2 includes an extended void region Sb. The extended void regions Sa and Sb are formed to have different cross-sectional areas as viewed in the axial direction. Further, the magnet 23 of each magnet pole 24 is arranged in the rotor core 22 so that the longitudinal direction of the magnet 23 as viewed in the axial direction of the rotor 3 is inclined by a magnet inclination angle θ1 relative to a straight line L2, which is orthogonal to a straight line L1 extending in the radial direction of the stator core 4 through the middle point of the first opposing surface 32a of the peripheral core portion 32 in the circumferential direction. As a result, the magnet 23 is inclined so that the end located at the rear side relative to the rotational direction as viewed in the axial direction is closer to the center of the rotor 3. At least one of the second opposing surfaces 32b and 32c, which are inwardly curved, may be squeezed for formation from the peripheral side. This increases the density at the end of the peripheral core portion 32 in the circumferential direction and further improves the demagnetization resistance.

Further, in the structure shown in FIG. 5, the surface of the peripheral core portion 41 defining the extended void region Sa is flat but not particularly limited in such a manner. For example, as shown in FIG. 12, the surface of the peripheral core portion 41 defining the extended void region Sa may be a curved surface 41b, which hollows toward the magnet 24. The curved surface 41b may be squeezed from the peripheral side for formation. This increases the density at the end of the peripheral core portion 41 that is closer to the void S1 and further improves the demagnetization resistance.

In the rotor 3 of the above embodiment, the shapes of the magnets 23 and the shape of the rotor core 22, which includes the peripheral core portions 32, the core poles 25, and the bridges 31, may be changed.

In the above embodiment, the rotor 3 includes eight magnet poles, namely, the four magnet poles 24 and the four core poles 25. However, the present invention is not limited in such a manner. The rotor 3 may include an (n+1) number (whereas n is a natural number) of magnet poles 24 and an (n+1) number of core poles 25, which total to 2(n+1) number of poles. Further, in the above embodiment, the stator 2 includes twelve teeth 12 and twelve slots. The stator 2 may include 3(m+1) number (whereas m is a natural number) of slots.

The numerical ranges in the above embodiment may be changed as required.

The brushless motor 1 in the above embodiment is of an inner rotor type but may be of an outer rotor type.

The present examples and embodiments are to be considered as illustrative and not restrictive, and the invention is not to be limited to the details given herein, but may be modified within the scope and equivalence of the appended claims.

1. A brushless motor comprising:
a rotor including a rotor core, wherein the rotor core includes a plurality of magnet poles, which are arranged in a circumferential direction of the rotor core, and a plurality of core poles, each arranged between two adjacent ones of the magnet poles in the circumferential direction, a magnet is embedded in each of the magnet poles, and a void is formed at a boundary between each of the core poles and an adjacent one of the magnet poles in the circumferential direction; and
a stator including a plurality of teeth, which are arranged at equal angular intervals in the circumferential direction facing the rotor in a radial direction of the rotor, and a plurality of coils wound around the teeth respectively,
wherein each magnet pole includes a peripheral core portion located closer to the stator than the corresponding magnet in the radial direction of the rotor, and at least one of the two voids formed at opposite circumferential sides of each magnet pole includes an extended void region that extends into the corresponding peripheral core portion and toward a middle point of the magnet pole in the circumferential direction.

2. The brushless motor according to claim 1, wherein
each peripheral core portion includes a first opposing surface, which faces the teeth and is spaced apart from the teeth by a first distance, and a second opposing surface, which faces the teeth with the extended void region arranged in between and is spaced apart from the teeth by a second distance that is greater than the first distance.

3. The brushless motor according to claim 2, wherein
the first opposing surface has a circumferential width and each tooth include a distal surface having a circumferential width that is equal to the circumferential width of the first opposing surface.

4. The brushless motor according to claim 2, wherein each magnet is formed by a rectangular plate and is embedded in the rotor core in a state in which a long side of the magnet, as viewed in an axial direction of the rotor, is inclined at a magnet inclination angle θ1 relative to a straight line that is orthogonal to a straight line extending in a radial direction of the rotor core through a circumferential middle point of the corresponding first opposing surface,
the second opposing surface is flat and inclines at a void inclination angle θ2 relative to a short side of the magnet,
the magnet inclination angle θ1 is set in a range of 0°≦θ1≦22.5°, and
the void inclination angle θ2 is set in a range of θ2≦45°.

5. The brushless motor according to claim 2, wherein the second opposing surface is curved away from the stator as viewed in an axial direction of the rotor.

6. The brushless motor according to claim 5, wherein
the rotor includes an (n+1) number (whereas n is a natural number) of the magnet poles and an (n+1) number of the core poles that total to 2(n+1) number of poles,
the stator includes 3(m+1) number (whereas m is a natural number) of slots,
each of the magnet poles includes the first opposing surface, which is located in a circumferentially middle part of the peripheral core portion, and the second opposing surface, which is located at each of two circumferential sides of the first opposing surface,
each of the magnet poles is formed to be symmetric relative to a straight line extending in a radial direction of the stator core through a circumferential middle point of the magnet pole,
when E represents a distance from two circumferential ends of each peripheral core portion to a hypothetical circle lying along a surface of the rotor and A represents a distance from the corresponding first opposing surface to a distal surface of each tooth in the radial direction, a ratio E/A is set to 0, and
when W1 represents a circumferential width of the first opposing surface in each peripheral core portion and W2 represents a circumferential width of each magnet, a ratio W2/W1 is set in a range of 1.0<W2/W1<2.1.

7. The brushless motor according to claim 6, wherein
the rotor includes eight magnet poles, which are four of the magnet poles and four of the core poles, and
the stator includes twelve of the teeth and twelve slots.

8. The brushless motor according to claim 5, wherein
the rotor includes an (n+1) number (whereas n is a natural number) of the magnet poles and an (n+1) number of the core poles that total to 2(n+1) number of poles,
the stator includes 3(m+1) number (whereas m is a natural number) of slots,
each of the magnet poles includes the first opposing surface, which is located in a circumferentially middle part of the peripheral core portion, and the second opposing surface, which is located at each of two circumferential sides of the first opposing surface,
each of the magnet poles is formed to be symmetric relative to a straight line extending in a radial direction of the stator core through a circumferential middle point of the magnet pole,
when E represents a distance from two circumferential ends of each peripheral core portion to a hypothetical circle lying along a surface of the rotor and A represents a distance from the corresponding first opposing surface to a distal surface of each tooth in the radial direction, a ratio E/A is set to 4 or less, and
when W1 represents a circumferential width of the first opposing surface in each peripheral core portion and W2 represents a circumferential width of each magnet, a ratio W2/W1 is set in a range of 1.2<W2/W1<1.8.

9. The brushless motor according to claim 8, wherein
the rotor includes eight magnet poles, which are four of the magnet poles and four of the core poles, and
the stator includes twelve of the teeth and twelve slots.

10. The brushless motor according to claim 1, wherein the rotor core includes two bridges that support each peripheral core portion and extend along two circumferential ends of each magnet.

11. The brushless motor according to claim 1, wherein the rotor core includes a bridge connecting the peripheral core portion to an adjacent one of the core poles and extending along the circumferential direction of the rotor core, and
the bridge covers the void with a portion of the bridge located close to the stator.

12. The brushless motor according to claim 11, wherein the peripheral core portion includes a surface opposing the teeth and having a circumferential width, and each tooth includes a distal surface having a circumferential width that is equal to the circumferential width of the opposing surface of the peripheral core portion.

13. The brushless motor according to claim 10, wherein the bridge includes a plurality of holes arranged in an axial direction.

14. The brushless motor according to claim 13, wherein
the rotor core includes core sheets stacked in the axial direction, and
each of the holes is formed by a recess formed in each core sheet.

15. The brushless motor according to claim 11, wherein the bridge includes a plurality of holes arranged in an axial direction.

16. The brushless motor according to claim 15, wherein
the rotor core includes core sheets stacked in the axial direction, and
each of the holes is formed by a recess formed in each core sheet.
